(19) United States
(12) Patent Application Publication
(10) Pub. No.: US 2004/0129327 A1
(43) Pub. Date: Jul. 8, 2004

(54) Test plug closure

(76) Inventor: Robert A. Hooper, Wayzata, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/742,141

(22) Filed: Dec. 22, 2003

Related U.S. Application Data
(60) Provisional application No. 60/436,775, filed on Dec. 26, 2002.

(51) Int. Cl. F16L 55/10

(52) U.S. Cl. 138/90; 138/89

(57) ABSTRACT

A pipe test plug device for testing pipes includes a coupling and a quick release seal that includes pull points to allow the seal to controllably break free and be removed in pieces whether the pipe to be tested is plastic or metallic.

### CROSS-REFERENCE TO RELATED APPLICATIONS

This application claims benefit to U.S. Provisional patent application serial No. 60/436,775 filed Dec. 26, 2002, the disclosure of which is incorporated herein by reference.

### STATEMENT REGARDING FEDERALLY SPONSORED RESEARCH OR DEVELOPMENT

Not Applicable.

### BACKGROUND OF THE INVENTION

This invention relates to fittings for pressure testing pipe connections, and more specifically to permanently installed test plug closures that have a closure which is readily removed after testing.

Plumbers are required to test their assembled pipes to ensure that no leaks are present. Otherwise, a leaking pipe would be sealed behind a finished wall which would greatly increase the costs associated with correcting the leak. The pipes to be tested must be closed off with a test closure that allows the closed system to be filled with water, air or any other fluid such that leaks may be observed visually or by a decrease in fluid pressure.

Typically, a rubber pipe plug is inserted at an easily accessible junction point that may be reopened after testing to remove the rubber pipe plug. Examples of such devices are found in a series of patents to Huber, typified by U.S. Pat. Nos. 6,082,183; 6,209,584; 6,032,515 and 5,163,480. Other approaches include a sealing disc that is glued or waxed in place against a bevel in the pipe such as shown in U.S. Pat. No. 5,507,501 to Palmer. Another sealing plug is described in Bevacco, U.S. Pat. No. 6,182,704 which has a disk which comes apart in pieces leaving behind a ring portion. Finally, U.S. Pat. Nos. 4,602,504 and 4,706,482 to Barber show an approach in which a fitting may be permanently glued into the pipe, with a large portion of the seal being removable like a tennis can lid.

It is desirable to have an inexpensive test plug device that may be easily inserted and removed such that substantially full flow is maintained. Due to the costs of labor, the plumber's time should be minimized. All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. § 1.56(a) exists.

### BRIEF SUMMARY OF THE INVENTION

The invention provides a permanent coupling test plug for both plastic and metal pipe fittings. For plastic pipes, such as PVC and ABS pipes, the inventive device includes a single molded plastic coupling that includes a male and female end for attaching to a pipe and further includes a quick release seal. For metallic pipes such as cast iron pipes, the same quick release seal is employed encased within a molded rubber coupling that is attached to the cast iron pipe as in standard rubber couplings.

The quick release seal of the invention includes multiple break lines molded into the seal along with pull points that allow the seal to be broken when desired by pulling on a line attached to the pull points. The seal breaks into multiple parts that are attached to the line or lines such that they may be removed easily, even through a smaller diameter pipe. In the all plastic coupling of the invention, the quick release seal is molded in a single step with the coupling itself. With the metal pipe fitting form, the seal is fabricated and is placed in a mold into which the rubber coupling is formed with the rubber encasing the seal.

These and other embodiments which characterize the invention are pointed out with particularity in the claims annexed hereto and forming a part hereof. However, for a better understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE DRAWINGS

A detailed description of the invention is hereafter described with specific reference being made to the drawings in which:

FIG. 1 is a perspective view of a coupling of the invention;

FIG. 2 is a cross-sectional view of the plug of FIG. 1 through lines 2-2;

FIG. 3 is a front end view of the plug of FIG. 1;

FIG. 4 is a perspective view of an alternative plug of the invention;

FIG. 5 is a cross-sectional view of the plug of FIG. 4 through line 5-5;

FIG. 6 is a side elevational view of a coupling with the plug of FIG. 4 with parts broken away;

FIG. 7 is an alternative embodiment of the invention showing a plug in a tee fitting;

FIG. 8 is a enlarged portion from FIG. 6 showing the engagement of the seal to the rubber coupling; and

FIG. 9 is a perspective view of an alternative metal seal of the invention.

### DETAILED DESCRIPTION OF THE INVENTION

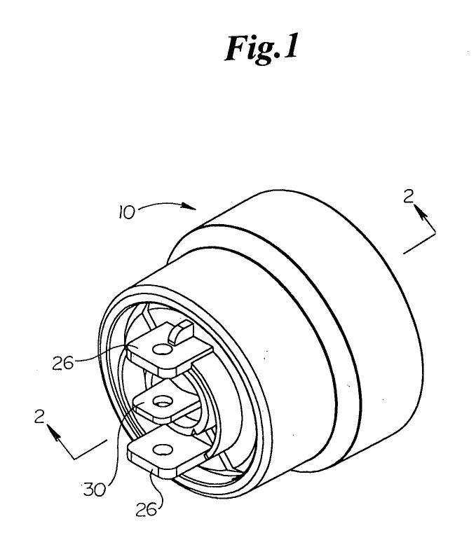

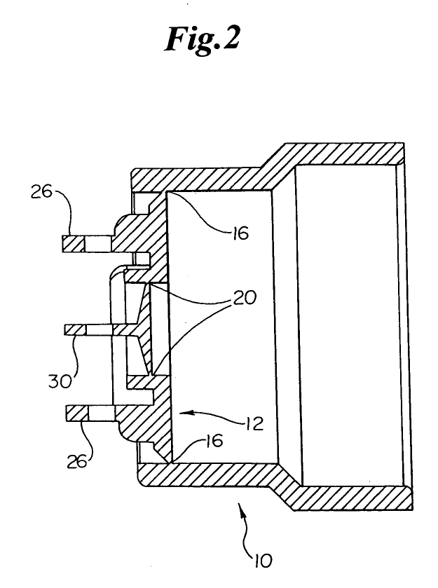

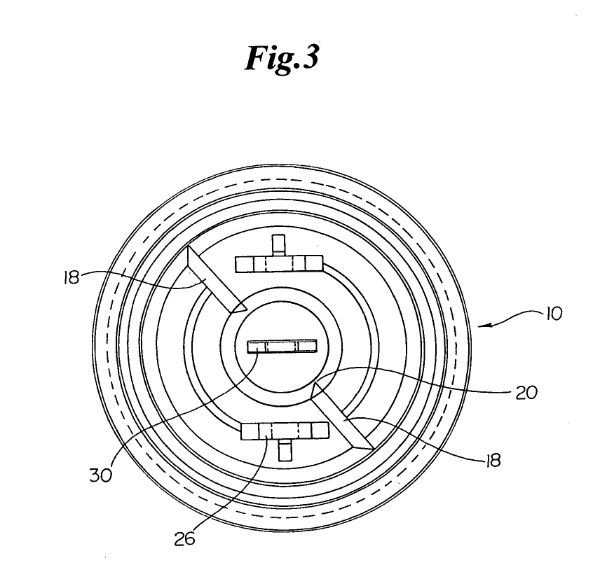

FIGS. 1 through 3 show a coupling 10 of the invention which has a standard coupling body that includes a male end and a female end for socket welding to pipes. It further includes the novel center seal 12 which provides the temporary seal for pressure testing of the installed system. After the pressure test has been conducted successfully, the line is opened by removing the temporary seal 12.

As shown in the figures, the seal 12 is molded during fabrication of the coupling 10 to include a main disc 14 that has a peripheral edge 16 that abuts with the center of the coupling 10 that has a thin web of plastic to form a break point that allows the seal to be broken free with hand pressure. The seal includes a series of other thin webs of plastic that also form break lines, shown as lines 18 and 20. Break line 20 is generally circular and describes a periphery about a hub 22 that extends out of the coupling. In turn, the remainder of the seal 12 is removed in manageable pieces by pulling on molded line attachment points 26 on each section defined by the break lines of 16, 18 and 20, of which four are shown in the drawings. Obviously, more or less sections may be formed as desired. By attaching lines to each of the line attachment points 26, a user may pull on the lines until the seal breaks at break points 16, 18 and 20, causing each section to break cleanly away from the coupling. Each of the pieces is small enough to pass through the pipe easily and is attached to the tether line for easy removal.

Note that the disc 14 of FIGS. 1 through 3 breaks into three discrete sections, with a total of three line attachment points 26 and 30.

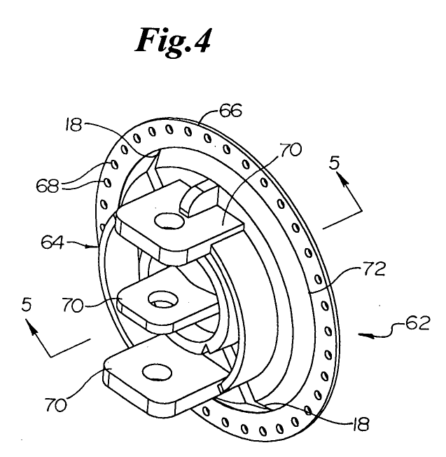

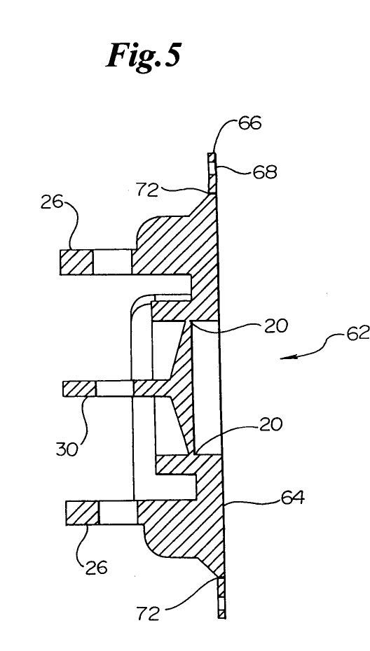

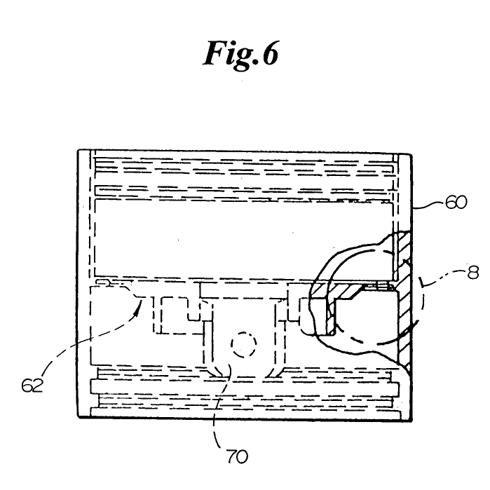

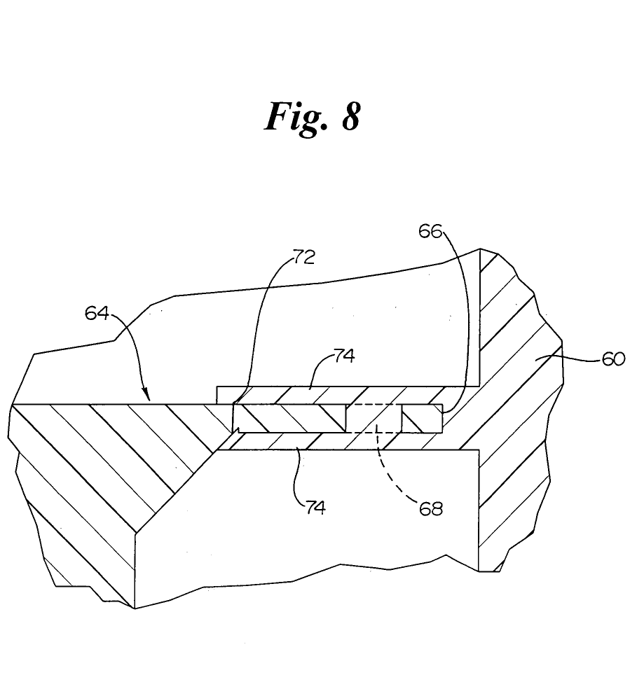

The inventive seal for the test plug of the invention may be directly molded in cases such as PVC or ABS couplings and other fittings as described previously. In addition, the seal may be used in a test plug for cast iron pipes where the coupling is required to be a non-metallic union. FIGS. 4 through 6 shows a form of the invention in which the seal is still the disk shaped member that separates into several pieces for removal, but is held within a rubber coupling 60. The rubber coupling 60 is basically derived from standard rubber metal pipe connectors and has a plurality of inner ridges at its end which help make a seal to the metal pipe when pipe clamps are applied over the surface. In addition, the inventive test plugs of the invention for metal pipes include a plastic seal 62 which is a disc 64 having an outer periphery 66, spaced through holes 68 adjacent that periphery, line attachment points 26 and break lines 18 and 20 which will cause the seal 62 to break apart into discrete, manageable sections that may be removed by continuing to pull on line attached to the attachment points 70. In order to make a fluid tight seal, the rubber coupling 60 is molded around the seal 62 which encases the seal in rubber about the backside and periphery and passes through the holes 68 to firmly seat the seal 62 within the coupling as best shown in FIG. 8. The plastic seal 62 rips easily from the rubber leaving an open conduit. The seal portion between circular break line 72 and the outer periphery 66 remains buried in the rubber of the rubber coupling 60. As best shown in FIG. 8, the rubber coupling 60 when formed about the seal 62 encases the outer periphery 66 to the inner break line 72 with a rubber flange 74 that locks the seal in place through the holes 68. When the seal is pulled free, it may cause the rubber flange 74 to partially or completely break free from the remainder of the rubber coupling 60. The seal 62 may also be formed from metal or even rubber.

The seal may either be encased in rubber of a rubber connector for metal pipe or may be placed in the mold for a plastic coupling mold such that the seal is preformed before the full plastic coupling or other plastic fitting is molded.

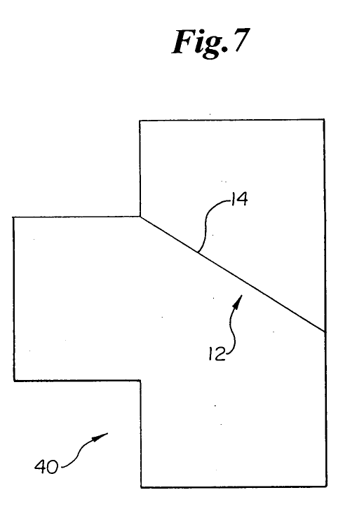

FIG. 7 illustrates that the test plug of the invention may be fabricated within any conventional pipe fitting, such as a Tee 40, with the seal 12 being molded in to close off at least one leg of the Tee. The seal 12 would have the same disc 14 and break lines 16, 18 and 20 and may or may not include a center hub.

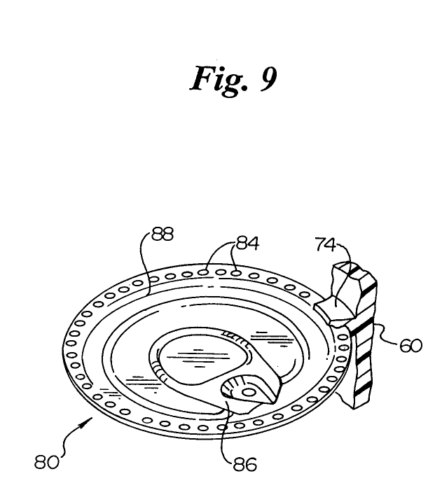

FIG. 9 shows an embodiment of the invention in which a metal disk 80 is used like the disc 14 of FIGS. 4 through 6. A plurality of holes 82 at the periphery 84 are formed in the metal disk 80. This allows the disk 80 to be molded into a rubber coupling 60 and held securely. Alternatively, such a disk 80 may be molded into a plastic coupling such as a Tee of coupling as in FIG. 1 with plastic flowing through said holes 82 to lock the disk 80 into the fitting. In either case, the disk has a tab 86 which may be pulled up to exert force against a perimeter 88 which allows the perimeter to peel off and separate the metal within the perimeter and to be removed with the tab. Such constructions are well known in the art of metal can lids as in peanut can lids.

While this invention may be embodied in many different forms, there are shown in the drawings and described in detail herein specific preferred embodiments of the invention. The present disclosure is an exemplification of the principles of the invention and is not intended to limit the invention to the particular embodiments illustrated.

This completes the description of the preferred and alternate embodiments of the invention. Those skilled in the art may recognize other equivalents to the specific embodiment described herein which equivalents are intended to be encompassed by the claims attached hereto.

1. A test plug closure for testing pipe systems comprising:
a molded plastic pipe fitting having at least one inlet and at least one outlet in fluid communication therewith, said pipe fitting having a seal molded across and preventing flow through at least one outlet, said seal comprising a generally disc shaped member having a break line around the circumference of the seal which allows the seal to be removed from said pipe fitting, said seal further including at least one line attachment member for attaching a line thereto to aid in breaking the seal free from the remainder of said pipe fitting at said break line.

2. The test plug closure of claim 1 further including at least one additional break line constructed and arranged to break said seal into at least two discrete sections, each of said sections including a line attachment member.

3. The test plug of claim 1 wherein said pipe fitting is a pipe coupling.

4. The test plug of claim 1 wherein said pipe fitting is a tee.

5. A test plug closure for testing pipe systems comprising:
(a) a molded plastic pipe fitting having at least one inlet and at least one outlet in fluid communication therewith; and
(b) a plastic molded seal formed within said pipe fitting preventing flow through at least one outlet, said seal comprising a generally disc-shaped member having an outer periphery which forms a break line about which said seal may be removed from said pipe fitting, said seal further including at least one line attachment member for attaching a line thereto to aid in breaking the seal free from the pipe fitting at said outer periphery.

6. The test plug closure of claim 5 wherein said molded plastic seal includes at least one additional break line constructed and arranged to break said seal into at least two discrete sections, each of said sections including a line attachment member.

7. A test plug closure for testing cast iron pipe systems comprising:
a) a rubber coupling having an inlet and an outlet which may be connected to a cast iron pipe system to be tested;
b) a seal for preventing flow through said rubber coupling, said seal comprising a generally disc-shaped member having an outer periphery which is encased and held to said rubber coupling and an inner break line about which said seal within said inner break line may be removed from said rubber coupling, said seal further including at least one line attachment member for attaching a line thereto to aid in breaking the seal within said inner break line free from the rubber coupling at said outer periphery.

8. The test plug closure of claim 7 wherein said rubber coupling is formed about said seal and said seal has a plurality of discrete through holes between its outer periphery and said break line through which rubber may flow during formation of the rubber coupling to lock said seal to said rubber coupling.

9. The test closure of claim 8 wherein said seal is formed of plastic.

10. The test closure of claim 8 wherein said seal is formed of metal.
